(19) United States
(12) Patent Application Publication
(10) Pub. No.: US 2004/0080086 A1
(43) Pub. Date: Apr. 29, 2004

(54) Resilient bushing mount for a vehicle suspension

(76) Inventors: Mark J. Mansueto, Utica, MI (US); Mark C. Smith, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/278,299

(22) Filed: Oct. 23, 2002

(51) Int. Cl. F16F 7/00; F16F 1/36; B60G 11/22

(52) U.S. Cl. 267/292; 267/141

(57) ABSTRACT

A vehicle suspension includes a mount assembly for a gas strut. The mount system includes a resilient bushing supported upon an annular carrier. A rigid annular member is mounted within an inner diameter of the resilient bushing. The resilient bushing, the annular carrier, and the annular member are symmetrical about an equator. The resilient bushing, the annular carrier, and the annular member are of a two-piece structure which are mirror images when reflected through the equator. The two-piece structure allows rapid assembly, simplification of manufacture, and assembly into the vehicle structure. Another mount system includes a one-piece resilient bushing having a cylindrical annular carrier.

### BACKGROUND OF THE INVENTION

The present invention relates to a gas strut for a vehicle suspension, and more particularly to a resilient bushing which mounts a gas strut to a vehicle.

Various types of vehicle suspensions are employed in modern vehicles. One type of common suspension is a McPherson strut suspension. The strut typically includes a hydraulic damper with a knuckle secured to the damper by fasteners. A coil spring is secured to the upper portion of the strut between the strut and the vehicle frame. A wheel end is supported on the knuckle, and the strut turns in response to a steering input on the knuckle to turn the vehicle.

Normally a thrust-bearing support assembly supports the upper end of a MacPherson strut of a vehicle suspension member. The bearing engages the top of the strut and is supported in an annular, resiliently deformable bush made of rubber. The outside of the bush is bonded to a mounting plate which is bolted to the underside of a suspension tower built into the upper part of a wheel arch of the vehicle. The bearing allows the strut to turn about its vertical axis when the front wheel is turned, and the rubber bush accommodates axial vibration and tilting of the strut which occurs when the vehicle is traveling over rough ground.

It is important that the strut be mounted so that the wheel is held at the correct angle. However, the mounting structure must provide some resilience to minimize the transfer of noise and vibration. These design requirements increase the complexity of the strut mounting structure which may increase manufacturing difficulty, assembly difficulty and expense.

Accordingly, it is desirable to provide a simplified strut mounting structure that simplifies assembly while maintaining effective support of the gas strut with minimal vibration transfer.

### SUMMARY OF THE INVENTION

The vehicle suspension according to the present invention provides a vehicle suspension which utilizes a gas strut which is mounted to a vehicle frame by a resilient mount system. The mount system includes a resilient bushing supported upon an annular carrier. A rigid annular member is mounted within an inner diameter of the resilient bushing to define the distance between a retention plate and a spring seat.

The resilient bushing, the annular carrier, and the annular member are symmetrical about an equator defined about the axis of the gas strut. The resilient bushing, the annular carrier, and the annular member are formed of two-pieces which are mirror images. The two-pieces allow rapid assembly without concern for parts matching which simplifies manufacturability and assembly into the vehicle structure.

Another mount system includes a one-piece resilient bushing, annular carrier, and an annular member which are symmetrical about an equator. The annular carrier is cylindrical to ease assembly of the one-piece resilient bushing through the vehicle frame. An arcuate chamfered axial end of the resilient bushing further assists assembly.

The present invention therefore provide a simplified strut mounting structure that simplifies assembly into the vehicle yet maintains effective support of the gas strut while minimizing vibration transfer.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a general perspective view of a vehicle suspension;

FIG. 2 is a sectional view of a mount system according to the present invention;

FIG. 3 is a side perspective view of a bushing for the mount system illustrated in FIG. 2;

FIG. 4 is a top perspective view of the bushing illustrated in FIG. 3;

FIG. 5 is a sectional view of another mount system according to the present invention;

FIG. 6 is a side perspective view of a bushing for the mount system illustrated in FIG. 5; and

FIG. 7 is a top perspective view of the bushing illustrated in FIG. 6.

### DETAILED DESCRIPTION OF THE PREFERRED EMBODIMENT

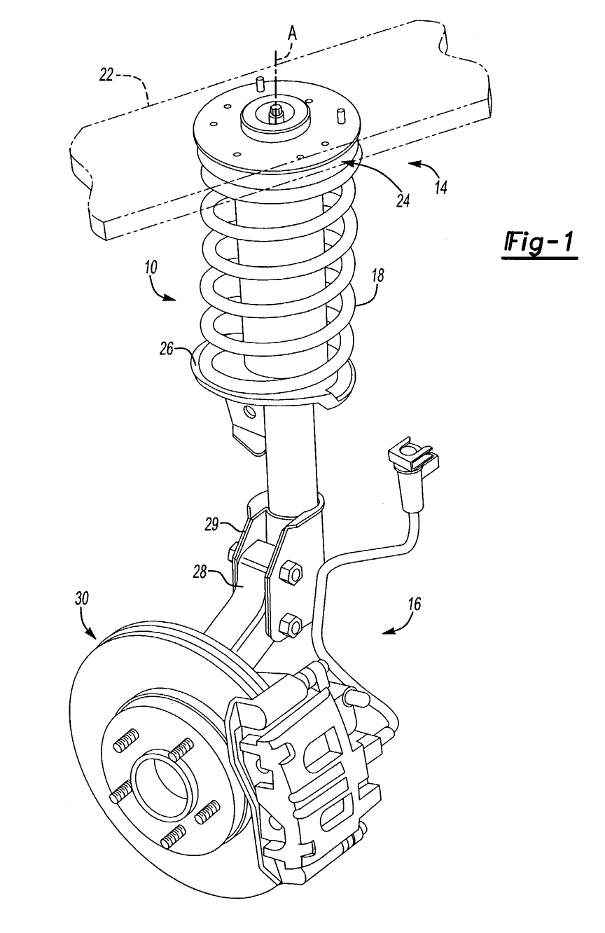

FIG. 1 illustrates a general perspective view of a vehicle suspension 10 utilizing a gas strut such as a McPherson strut 12 which defines an axis A. The strut 12 includes upper 14 and lower 16 portions. The upper portion 14 supports a spring 18 such as a coil spring. The upper portion 14 is supported on the vehicle frame (illustrated schematically at 22) by a resilient mount system 24.

The spring 18 is retained between the mount system 24 and a fixed lower spring mount 26 attached to the strut 12. The strut 12 provides hydraulic dampening for a wheel knuckle 28 mounted at the lower portion 16 through a bracket 29 or the like. The knuckle 28 supports a brake assembly 30 and a wheel (not shown) as is well known. The strut 12 may rotate in response to a steering input, as is also generally known in the art.

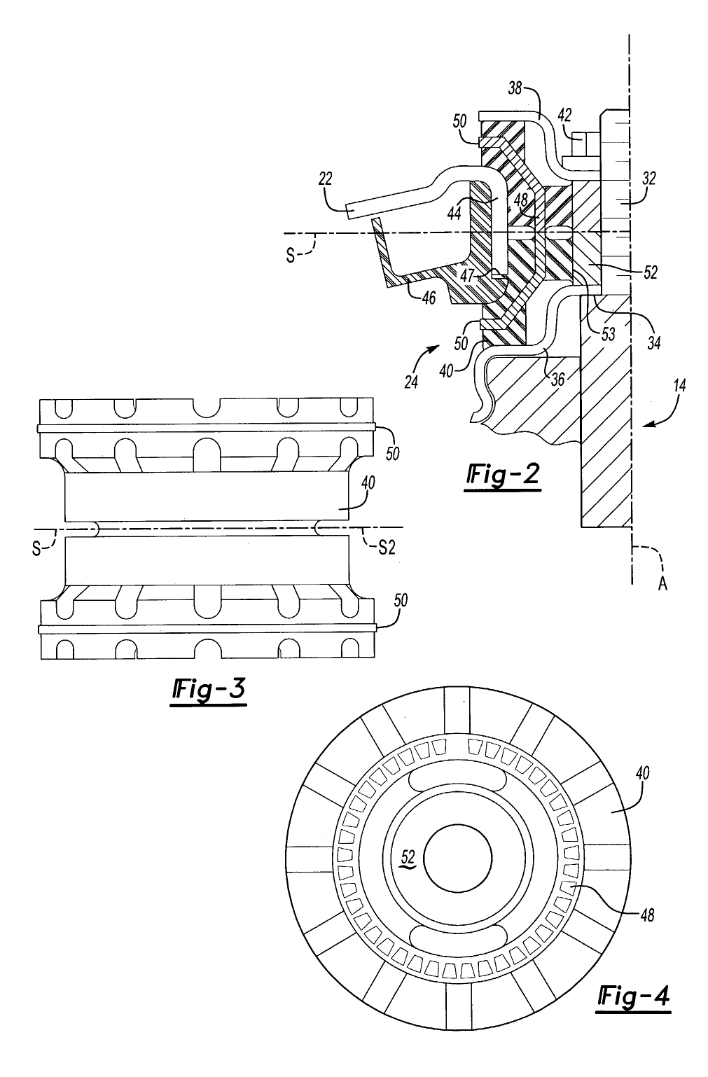

Referring to FIG. 2, a radial sectional view which passes through axis A further illustrates the mount system 24. The upper portion 14 of the strut 12 preferably includes a threaded section 32 of a smaller diameter than the strut 12 to define a step 34. An annular spring seat 46 forms the lower portion of mount system 24. The spring seat 46 is located upon the threaded section 32 adjacent the step 34 to retain the upper end of the spring 18 (FIG. 1).

An annular upper retention plate 38 forms the upper portion of mount system 24. The retention plate 38 is separated from the spring seat 46 by a resilient bushing 40. Preferably, a threaded fastener 42 is threaded upon the threaded section 32 to compresses the resilient bushing 40 between the retention plate38 and the jounce bumper 36. The retention plate 38 and the spring seat 36 are preferably cup shaped members with their open ends facing away from each other. The resilient bushing 40 of the mount system 24 resiliently retains the strut 12 to a cylindrical opening 44 in the vehicle frame 22 such that vibration transfer therebetween is minimized.

Preferably, a bearing seat 46 is mounted about the cylindrical opening 44 to provide further support thereof and assist in the insertion of the resilient bushing 40 by covering an open edge 47 of the cylindrical opening 44. The bearing seat 46 is also at least partially retained by the resilient bushing 40. It should be understood that various vehicle frame and suspension structure will benefit from the mounts system of the present invention and that the present invention is not limited to the illustrated embodiment.

The resilient bushing 40 is supported upon an annular carrier 48. The annular carrier 48 is preferably a rigid member surrounded by the resilient bushing 40 (FIG. 3). That is, the annular carrier 48 is essentially encapsulated by the resilient bushing 40. “Encapsulated” as defined herein means the resilient bushing 40 essentially surrounds the annular carrier 48, however, edge portions 50 (FIG. 3) or the like the annular carrier 48 can extend at least partially through the resilient bushing 40. The annular carrier 48 is preferably cup shaped facing outward relative axis A and essentially forms a hub upon which the resilient bushing 40 is molded.

A rigid annular member 52 is mounted within an inner diameter 53 of the resilient bushing 40 (FIG. 4). The annular member 52 is a rigid bushing which defines the distance between the retention plate 38 and the spring seat 46. That is, a portion of the retention plate38 and the spring seat 24 contact the annular member 52 such that a proper compression is applied to the resilient bushing 40 when the threaded fastener 42 is threaded upon the threaded section 32.

Preferably, the resilient bushing 40, the annular carrier 48, and the annular member 52 are symmetrical about an equator S defined about the axis A. In other words, the resilient bushing 40, the annular carrier 48, and the annular member 52 are of a two-piece structure which are preferably mirror images when reflected through the equator S. The two-piece structure allows rapid assembly in cylindrical opening 44. Moreover, as the annular carrier 48 at least partially surrounds an inner diameter of the cylindrical opening 44 and the bearing seat 46, a two-piece structure is required to utilize carrier 48.

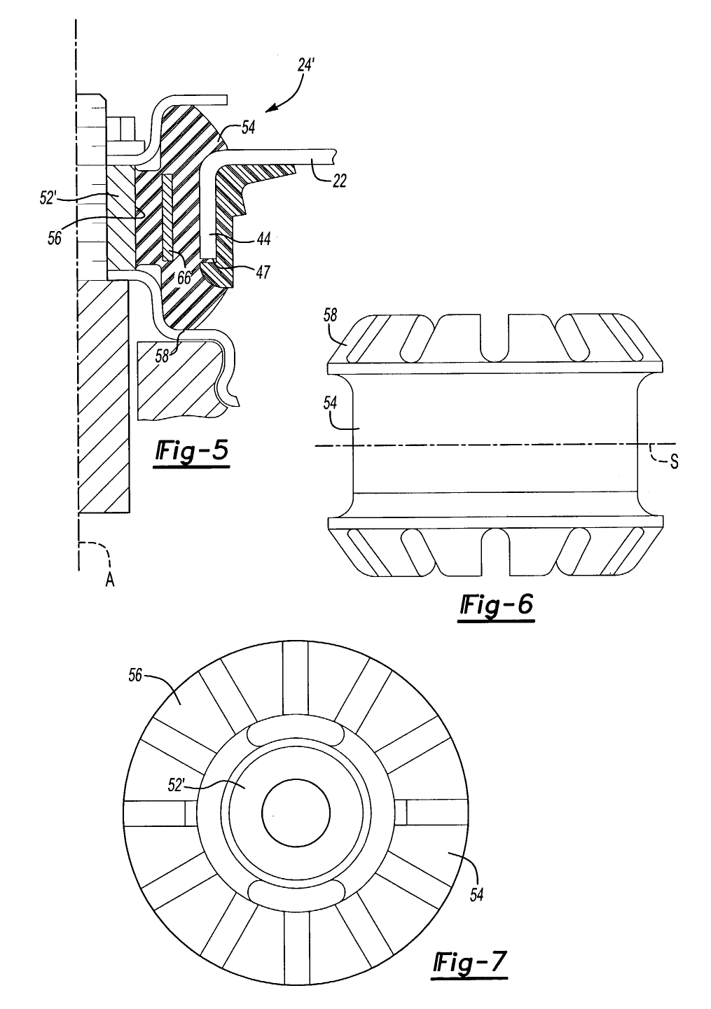

Referring to FIG. 5, a radial sectional view which passes through axis A of another mount system 24′ is illustrated. Mount system 24′ includes a one-piece resilient bushing 54, an annular carrier 56, and an annular member 52′ which are symmetrical about an equator S defined about the axis A (FIG. 6). In other words, the resilient bushing 54, the annular carrier 56, and the annular member 52′ are single component which is a mirror image when reflected through the equator S.

The annular carrier 56 is preferably cylindrical to allow the one-piece resilient bushing 54 to be inserting through the edge 47 of the cylindrical opening 44 in the vehicle frame 22. The annular member 52′ is mounted within an inner diameter 56 of the resilient bushing 54 (FIG. 7) and functions as described above.

The one-piece resilient bushing 54 preferably includes an arcuate chamfered axial end 58. The chamfered arcuate axial end 58 further assists in inserting the resilient bushing 54 through the edge 47 of the cylindrical opening 44 in the vehicle frame 22.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A resilient mount system for a gas spring of a vehicle suspension comprising:
an annular carrier which defines an axis; and
a resilient member mounted about said annular carrier, said resilient member symmetrical about an equator.

2. The resilient mount system as recited in claim 1, wherein said annular carrier and said resilient member are separable along said equator.

3. The resilient mount system as recited in claim 1, wherein said resilient member encapsulates said annular carrier.

4. The resilient mount system as recited in claim 1, further comprising a rigid annular member mounted within an inner diameter of said resilient member.

5. The resilient mount system as recited in claim 4, wherein said rigid annular member comprises a tubular bushing.

6. The resilient mount system as recited in claim 1, further comprising an upper mount and a lower mount, said resilient member mounted between said upper and lower mount such that an outer diameter of said resilient member engages a vehicle member.

7. A resilient mount system for a gas spring of a vehicle suspension comprising:
a two-piece annular carrier which defines an axis, said annular carrier comprising an annular cup shaped structure facing away from said axis, said annular carrier symmetrical and separable about an equator;
a two-piece resilient member mounted about said annular carrier, said resilient member symmetrical and separable about said equator axis; and
a rigid annular member mounted within an inner diameter of said resilient member, said rigid annular member symmetrical and separable about said equator.

8. The resilient mount system as recited in claim 7, further comprising an upper mount and a lower mount, said resilient member mounted between said upper and lower mount such that an outer diameter of said resilient member engages a vehicle member.

9. The resilient mount system as recited in claim 8, further comprising a bearing seat which at least partially surrounds a cylindrical opening within said vehicle member, said resilient member engagable with said cylindrical opening.

10. A resilient mount system for a gas spring of a vehicle suspension comprising:
a cylindrical annular carrier which defines an axis;
a resilient member mounted about said annular carrier, said resilient member symmetrical about an equator; and
a rigid annular member mounted within an inner diameter of said resilient member.

11. The resilient mount system as recited in claim 10, further comprising a bearing seat which at least partially surrounds a cylindrical opening within a vehicle member, said resilient member engagable with said cylindrical opening.

12. The resilient mount system as recited in claim 11, wherein said bearing seat covers an edge of said cylindrical opening.

13. The resilient mount system as recited in claim 11, wherein said bearing seat provides a radius which covers a straight edge of said cylindrical opening.
